(19) United States
(12) Patent Application Publication
(10) Pub. No.: US 2026/0321243 A1
(43) Pub. Date: Oct. 15, 2026

(54) SPEECH GENERATION

(71) Applicants: Beijing Zitiao Network Technology Co., Ltd., Haidian District (CN); Bytedance Technology Ltd., Grand Cayman (KY)

(72) Inventors: Dongya Jia, Beijing (CN); Zhuo Chen, Los Angeles, CA (US); Jiawei Chen, Beijing (CN); Jian Wu, Los Angeles, CA (US); Chenpeng Du, Los Angeles, CA (US); Xiaobin Zhuang, Beijing (CN); Jian Cong, Beijing (CN); Chumin Li, Beijing (CN); Yuping Wang, Beijing (CN); Yuxuan Wang, Los Angeles, CA (US)

(21) Appl. No.: 19/179,864

(22) Filed: Apr. 15, 2025

(51) Int. Cl. G10L 13/08; G06N 3/045; G06N 3/08

(52) U.S. Cl. CPC G10L 13/08; G06N 3/045; G06N 3/08

(57) ABSTRACT

In a method for speech generation, text data and speech data corresponding to the text data are received, the speech data comprising a speech segment and a speech unit that follows the speech segment, the speech segment comprising at least one speech unit. A causal autoregressive module in a machine learning model determines a latent feature associated with the text data and the speech segment. A diffusion module in the machine learning model determines a prediction of the speech unit based on the latent feature. The machine learning model is updated based on the speech unit and the prediction of the speech unit. With these implementations, the latent feature may comprise various aspects of both of the text data and the speech data, and then the latent feature may work as the condition feature to control the diffusion module to output the speech data related to the next patch.

### FIELD

The present disclosure generally relates to speech generation, and more specifically, to methods, devices and computer program products for speech generation by a machine learning model.

### BACKGROUND

Nowadays, the machine learning technique has been widely used in speech generation. Specifically, the language model (LM) has demonstrated strong generative capabilities and scaling properties. Usually, discrete tokenization is used in the LM, while the discrete tokenization is not straightforward for the audio data. Although LM is used for generating speech data from text data, it cannot reconstruct complex speech data with high fidelity. At this point, it is desired to improve the accuracy of the speech generation.

### SUMMARY

In a first aspect of the present disclosure, there is provided a method for speech generation. The method comprises: receiving text data and speech data corresponding to the text data, the speech data comprising a speech segment and a speech unit that follows the speech segment, the speech segment comprising at least one speech unit; determining, by a causal autoregressive module in a machine learning model, a latent feature associated with the text data and the speech segment; determining, by a diffusion module in the machine learning model, a prediction of the speech unit based on the latent feature; and updating the machine learning model based on the speech unit and the prediction of the speech unit.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates an example environment for speech generation according to the machine learning technique;

FIG. 2 illustrates an example diagram for speech generation according to implementations of the present disclosure;

FIG. 3 illustrates an example diagram for a machine learning module for speech generation according to implementations of the present disclosure;

FIG. 4 illustrates an example diagram for determining the latent feature according to implementations of the present disclosure;

FIG. 5 illustrates an example diagram of a diffusion module according to implementations of the present disclosure;

FIG. 6 illustrates an example procedure of temperature sampling according to implementations of the present disclosure;

FIG. 7 illustrates an example flowchart of a method for speech generation according to implementations of the present disclosure; and

FIG. 8 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

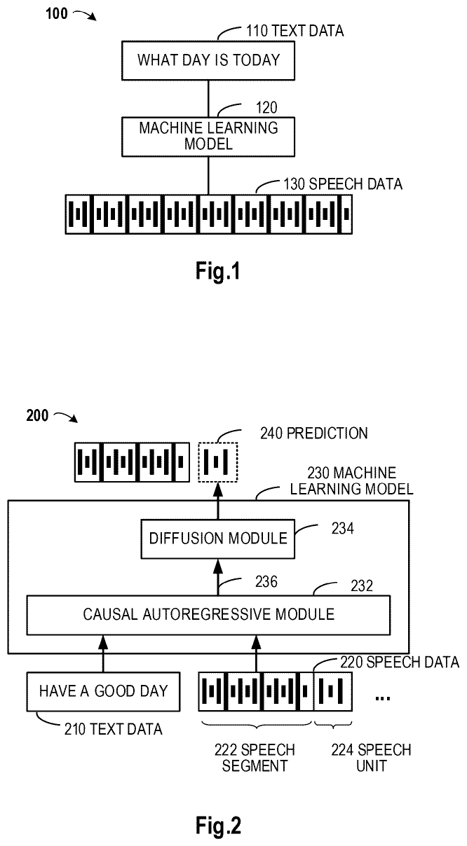

Referring to FIG. 1 to describe a general procedure of the speech generation, FIG. 1 illustrates an example environment 100 for speech generation according to the machine learning technique. In FIG. 1, text data 110 may be inputted into a machine learning model 120, here the text data 110 may be represented in the text format in a natural language. The machine learning model 120 may be built according to any appropriate architecture and may output speech data 130 that corresponds to the text data 110.

Various known architectures may be used for building the machine learning model 120. Recently, the autoregressive language model (LM) has demonstrated strong generative capabilities and scaling properties, where discrete tokenization is commonly used. While discretization is natural for the text, it is not as straightforward for the audio data. Due to bitrate limitations, discrete representation often fails to reconstruct complex modalities with high fidelity. In comparison, continuous tokens can better reconstruct the original audio information. To alleviate this challenge, a two-stage strategy is commonly applied for autoregressive multi-media generation, where a lossy discrete token is first generated by an LM, followed by a token-based diffusion for detail enrichment. However, such a cascaded design suffers from error accumulation and limits the scalability of the language model. Therefore, it is desired to achieve autoregressive modeling of continuous representations. Further, the diffusion model is effective at modeling continuous representations and may be integrated with autoregressive models. However, the performance significantly falls short when a causal-attention language model is used as the backbone.

Some solutions integrate the autoregressive language model and the diffusion model, however, the diffusion model does not naturally support the autoregressive generation of continuous tokens. These solutions repurpose language model parameters for diffusion, which significantly increases computational demands as the sequence lengthens and the language model size grows. It is desired to autoregressively predict continuous tokens while ensuring high-quality generation and maintaining reasonable computational demands.

Several recent solutions have attempted to auto-regressively generate continuous speech representations without discrete speech tokens by combining diffusion and autoregressive models, yet they often face challenges with excessive computational loads or suboptimal outcomes. In view of the above, the present disclosure proposes Diffusion Transformer Autoregressive Modeling (DiTAR). DiTAR is a patch-based autoregressive framework combining a language model with a diffusion transformer, which amalgamates the strengths of the causal-attention autoregressive and bidirectional-attention transformer diffusion.

The proposed solution may significantly enhance the efficacy of autoregressive models for continuous tokens and reduces computational costs. Generally, a divide-and-conquer strategy is used for patch generation, where the language model processes aggregated patch embeddings and the diffusion model subsequently generates the next patch based on the output of the language model. In the inference phase, a temperature parameter is defined as the time point of introducing noise during the reverse diffusion ODE (Ordinary Differential Equation) to balance diversity and determinism. In the extensive scaling analysis, the proposed solution has superb scalability. In zero-shot speech generation, the proposed solution achieves better performance in robustness, speaker similarity, and naturalness.

Referring to FIG. 2 for a general description of the proposed solution, FIG. 2 illustrates an example diagram 200 for speech generation according to implementations of the present disclosure. As illustrated in FIG. 2, the machine learning model 230 may comprise a causal autoregressive module 232 (which is implemented based on a language model) and a diffusion module 234. Specifically, the causal autoregressive module 232 may receive text data 210 and speech data 220, and then convert them into a latent feature. Further, the latent feature may be inputted into the diffusion module 234 for generating speech data. In a training phase, training sample with ground-truth may be used for training the machine module 230. In the inference phase, the trained model may receive data (for example, comprising text data and/or speech data) and may output corresponding speech data.

Referring to FIG. 2 to describe the training phase, the text data 210 and the speech data 220 corresponding to the text data 210 may be received. Here the speech data 220 may comprise a speech segment 222 and a speech unit 224 that follows the speech segment 222, and the speech segment 222 may comprise at least one speech unit. In the context of the present disclosure, the speech unit 224 may be a patch that is determined from the speech data 220 according to a predetermined interval. The causal autoregressive module 232 in the machine learning model 230 may determine a latent feature 236 associated with the text data 210 and the speech segment 222. The diffusion module 234 in the machine learning model 230 may determine a prediction 240 of the speech unit 224 based on the latent feature 236. Further, the machine learning model 230 may be updated based on the speech unit 224 and the prediction 240 of the speech unit 224 (for example, a difference between the speech 224 and the prediction 240). The above procedure may be implemented iteratively, and then the machine learning module 230 may describe an association between the text data and the speech data.

The proposed framework may seamlessly combine the diffusion model with a language model. In the proposed solution, the divide-and-conquer strategy may break continuous tokens into multiple patches. The language model may be responsible for inter-patch prediction, while the diffusion model may handle intra-patch prediction. Specifically, the diffusion model may have the bidirectional attention (DiT) to predict localized patches, named LocDiT (Local Diffusion Transformer). Furthermore, a broadly applicable guidance method is proposed to introduce historical contexts to LocDiT and to further enhance its generative capabilities. After patchification, the causal language model handling long contexts receives shorter sequences, further reducing computational load.

In the inference phase, the temperature-based sampling may balance exploration and exploitation and is crucial in discrete-valued language models. The temperature may be defined as the point at which noise is introduced along the reverse ODE trajectory and a temperature-based sampling method is proposed for the continuous-valued autoregressive model. Distinct from previous SDE-based solutions that require numerous steps, the proposed solution suits quicker ODE solvers and adeptly balances diversity with determinism.

The proposed solution provides a patch-based autoregressive framework that seamlessly blends LM and DiT, maintaining their strengths while offering superb generative capabilities and reduced computational demands. The proposed solution may be applied to zero-shot text-to-speech (TTS) that aims to generate speech from unseen speakers' prompts. Unlike existing systems using a coarse-to-fine pipeline, the proposed solution simplifies the process by having the language model directly predict final features, obviating the need for multiple stages. It may achieve better results in robustness, speaker similarity, and naturalness while demanding far less computational power.

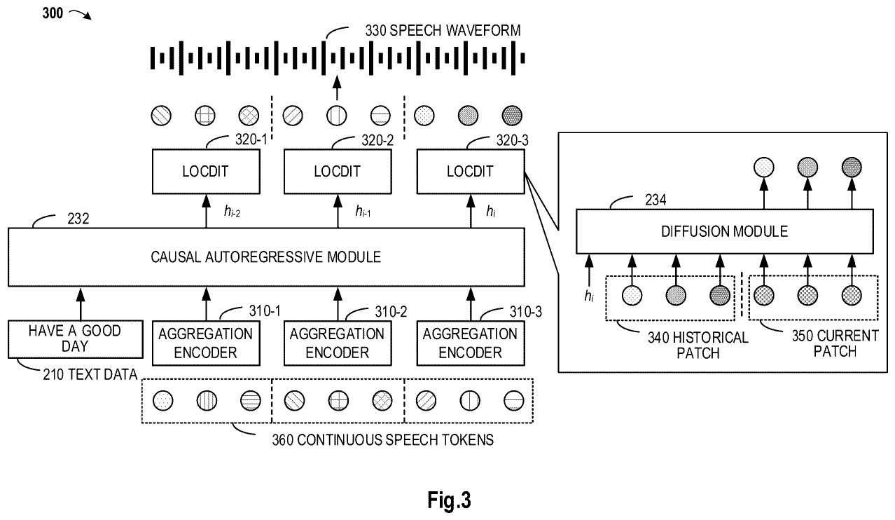

Referring to FIG. 3 to describe more details about the machine learning model, FIG. 3 illustrates an example diagram 300 for a machine learning module for speech generation according to implementations of the present disclosure. As illustrated in FIG. 3, the machine learning model may comprise an aggregation encoder. For the convenience of illustrating the input and output data of the encoder, a plurality of aggregation encoders 310-1, 310-2, . . . , and 310-3 are shown in FIG. 3, which may be referred to as the aggregation encoder 310 collectively. Actually, there may be one aggregation encoder 310 and the aggregation encoder 310 may be reused to process different input data and provide different output data. Specifically, the aggregation encoder 310 may determine the speech feature of the speech unit. Further, the machine learning model may comprise one LocDiT, and the LocDit corresponds to the diffusion module. Similarly, for the convenience of illustrating the input and output data of the LocDiT, a plurality of LocDiTs 320-1, 320-2, 320-3 and the like are shown in FIG. 3. Actually, there may be one LocDiT and the LocDiT 320 may be reused to process different input data and provide different output data.

In some implementations of the present disclosure, in order to determine the latent feature, an aggregation encoder in the machine learning model may determine at least one speech feature of the at least one speech unit; and the causal autoregressive module may determine the latent feature based on a text feature of the text data and the least one speech feature. With these implementations, the latent feature may comprise various aspects of both the text data and the speech data, and then the latent feature may work as the condition feature to control the diffusion module to output the speech data related to the next patch.

Specifically, the aggregation encoder 310 may determine the corresponding latent (represented by hᵢ). Here, the autoregressive model may provide next-token prediction. Considering a sequence of continuous tokens x=(x₁, x₂, . . . , x_{N}), the joint distribution of the sequence may be represented by the chain rule of probability:

$${p}_{θ} ( {x}_{1} , {x}_{2} , … , {x}_{N} ) = {\prod }_{i = 1}^{N} {p}_{θ} ( {x}_{i} \vert {x}_{1} , {x}_{2} , … , {x}_{i - 1} ) \qquad ( 1 )$$

In the above formula, θ denotes the parameters of an autoregressive generative model. Noting the high similarity among adjacent continuous tokens, it is evident that a bidirectional dependency exists within local regions. Based on this discovery, the local xᵢ may be aggregated into patches with a size of P, and then it adopts the bidirectional attention to model the tokens inside each patch. The model may be divided into two parts, θₐ and θ_{b}:θₐ denotes the autoregressive model responsible for long context learning via p_{θ}_{ₐ}(hᵢ|x₁, x₂, . . . , xᵢ), while θ_{b} denotes a bidirectional attention diffusion transformer executing next-patch prediction via p_{θ}_{ₐ}(xᵢ₊₁, . . . , x_{i+P}|hᵢ), where hᵢ is the output of language model and the condition for the diffusion model.

The effectiveness of the proposed solution may be validated on the zero-shot TTS (text-to-speech) task. Based on the formulation, the zero-shot TTS may be considered as a conditional continuation task for the autoregressive model, where prompting texts, target text, and prompting speech are concatenated and fed into the model as prefix context, then the model autoregressively generates the target speech given the context.

Regarding the overall architecture, the performance of the causal attention autoregressive model combined with diffusion loss is significantly inferior to systems utilizing full attention. To address the issue, a divide-and-conquer strategy is provided, where a long sequence of continuous tokens is divided into multiple patches. A language model is responsible for inter-patch prediction, while a diffusion transformer handles intra-patch prediction. The backbone of the proposed solution is a causal attention transformer with the next-token prediction. Each patch of continuous tokens is processed with an aggregation encoder into a single vector, which is then fed into the autoregressive model to get the output embedding hₜ. Here, hₜ serves as the condition of the following diffusion decoder (i.e., the LocDiT), and a diffusion loss is used for the output continuous tokens at training time.

In some implementations of the present disclosure, the speech unit (i.e., the patch) may be determined based on a predetermined interval from the speech data, the text feature of the text data may be determined based on at least one phoneme corresponding to the text data, and the latent feature may be determined based on a concatenation of the text feature of the text data and the least one speech feature. With these implementations, the continuous speech data may be divided into patches and then performance of the causal attention autoregressive model may be increased and meanwhile the computing workload may be alleviated. Further, the discrete patches may be more suitable for being processed by the LM.

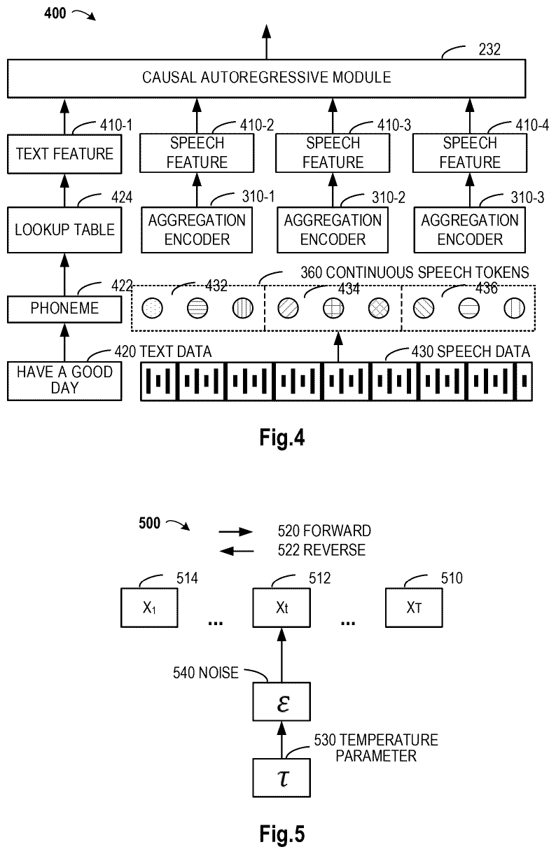

Referring to FIG. 4 for more details, FIG. 4 illustrates an example diagram 400 for determining the latent feature according to implementations of the present disclosure. As illustrated in FIG. 4, the text data 432 may be first converted into one or more phoneme 420, and then the phoneme 422 may be converted in the text feature 410-1 by a lookup table 424. Meanwhile, the speech data 430 may be divided into patches 432, 434 and 436. The patches may include corresponding tokens and form the continuous speech tokens 360. Further, the continuous speech tokens 360 may be inputted into the aggregation encoders 310-1, 310-2 and 310-3 to obtain the speech features 410-1, 410-3 and 410-4, respectively. Then, the text feature 410-1, and the speech features 410-1, 410-3 and 410-4 may be concatenated and the concatenation may be inputted into the causal autoregressive module 232. With these implementations, the causal autoregressive module 232 may output the corresponding latent feature hᵢ.

The diffusion model achieves success across numerous generative fields, and leverages the full receptive field of the bidirectional transformer to generate entire samples. LocDiT generates the next patch of speech given the autoregressive model's output. To capitalize on the context-learning potential of the diffusion transformer, a context-aware diffusion solution is provided. The LocDiT may generate localized continuous token patches iteratively. Specifically, returning back to FIG. 3, historical patches 340 of tokens are utilized as prefix inputs for the LocDiT (i.e., the diffusion module 234). Thereby, the next patch may be generated by the diffusion module 234 based on the historical patches 340 and the current patch 350, which may significantly improve the generation performance.

Furthermore, the design also implies an inherent coarse-to-fine manner. Current solutions commonly delineate both coarse and fine features. A language model typically predicts the coarse feature, while another network achieves the transition from coarse to fine. However, the multi-stage methods are prone to have cumulative errors. In contrast, the proposed solution function works in a seamless end-to-end manner, condensing each patch of tokens into an implicit lower-dimensional feature space that LocDiT subsequently expands into high-fidelity continuous tokens.

In some implementations of the present disclosure, in order to determine the prediction of the speech unit based on the latent feature, the latent feature may be updated according to a predetermined criterion; and the prediction of the speech unit may be determined based on the updated latent feature. With these implementations, effects of the latent feature may be weakened, and thus machine learning model is trained in a joint mode based on the unconditional and conditional mode, which may balance the trade-off between the diversity and fidelity.

Specifically, Classifier-Free Guidance (CFG) may be used in speech generation. CFG is extensively employed to enhance the condition adherence of generative models. In diffusion, the unconditional and conditional models share parameters and are jointly trained by intermittently omitting the condition during training. At inference, the outputs from these two models are merged with a parameter w balancing the trade-off between diversity and fidelity. This is equivalent to sampling under such a distribution \tilde{p}_{θ}(zₜ, c)∝p_{θ}(zₜ|c)p_{θ}(c|zₜ)^{w}, where θ denotes the model parameters, c denotes the condition and zₜ denotes the noisy sample at the time of t.

In the continuous-token LMs for conditional generation, the classification label may be incorporated into the diffusion head and applies CFG which significantly enhances performance. However, such a solution lacks generality. In the proposed solution, a more generalized solution is proposed, all conditions within the LM prefix inputs may be replaced and CFG is only applied to the diffusion decoder via the autoregressive model's on-the-fly output. The i^{th} output hᵢ of the autoregressive essentially represents all historical inputs (x₁, x₂, . . . , x_{N}). In some implementations, at least a portion of the latent feature may be replaced with predetermined values. For example, in order to update the latent feature, at least a portion of the latent feature may be cleared. Specifically, the hᵢ may be randomly selected and replaced with a null embedding along the sequence in training. At inference time, the following formula (2) may be used to from the distribution p_{θ}(z_{i,t}|x₁, . . . , xᵢ₋₁)p_{θ}(x₁, . . . , xᵢ₋₁|z_{i,t})^{w} by:

\tilde{ϵ}_{θ}(z_{i,t},hᵢ)=(1+w)ϵ_{θ}(z_{i,t},hᵢ)−wϵ_{θ}(z_{i,t}) (2)

In the above formula, z_{i,t} denotes the i^{th} noisy sample in the sequence at the time of t for diffusion, ϵ_{θ} denotes the score estimated by the LocDiT. Operating in the velocity space with a conditional flow-matching target is also equivalent. With these implementations, the speech generation may be implemented in an accurate and effective way.

Referring to FIG. 5 for a general description of the diffusion model, FIG. 5 illustrates an example diagram 500 of a diffusion model according to implementations of the present disclosure. The diffusion model is a class of generative models that have gained significant attention in recent years due to their ability to generate high-quality samples. The core idea behind the diffusion model is to iteratively transform a simple distribution (e.g., Gaussian noise) into a complex data distribution through a series of gradual steps. This process is inspired by non-equilibrium thermodynamics, where a system evolves from a state of order to disorder, or vice versa.

In a forward 520 process (Diffusion Process), it gradually adds noise to the data over a plurality of time steps. This is analogous to the physical process of diffusion, where particles spread out from a region of high concentration to a region of low concentration. Mathematically, the forward process may be described as a Markov chain where at each time step t, a small amount of Gaussian noise is added to the data from an initial state x₁. This process is defined by a variance schedule, which controls the amount of noise added at each step. The forward process transforms the data distribution into a simple Gaussian distribution after T steps, where x_{T} is typically pure noise.

A reverse 522 process (Denoising Process) is the generative part of the model, where the goal is to reverse the diffusion process and recover the original data from the noisy version. This is achieved by learning a neural network that predicts the noise added at each step of the forward process. The network is trained to minimize the difference between the predicted noise and the actual noise that was added during the forward process. Once trained, the model can generate new samples by starting from a random noise vector and iteratively denoising it through the reverse process.

The training objective of diffusion models is typically based on a variational lower bound on the data likelihood. The model is trained to minimize the difference between the predicted noise and the actual noise at each time step. This is often formulated as a weighted sum of mean squared errors (MSE) between the predicted and actual noise across all time steps. Once the model is trained, the trained model processes the inputted data sequence (including text data and/or speech data) and applies the reverse process step-by-step to generate new speech data sample. The reverse process is typically implemented as a sequence of denoising steps, where the model predicts the noise at each step and subtracts it from the current noisy sample to obtain a slightly less noisy version. Here, this paragraph only provides one implementation of the diffusion model, alternatively and/or in addition, the diffusion model may have a different structure.

In the inference procedure, the trained machine learning model may be used to infer speech from the text input. In some implementations of the present disclosure, the causal autoregressive module may determine a target latent feature associated with a data sequence in response to receiving the data sequence; and the diffusion module may determine a speech sequence corresponding to the data sequence based on the latent feature. With these implementations, the causal autoregressive module may convert the data sequence into the latent feature and then the latent feature may guide the diffusion module to generate corresponding speech sequence in an accurate way.

The data flow of the inference procedure is similar as that of the training procedure. For example, the encoders may convert the data sequence into corresponding tokens, and then these tokens may be inputted into the casual autoregressive module and then the latent feature may be outputted. Further, the diffusion module may use the latent feature as the conditional signal to generate the speech output.

In some implementations of the present disclosure, a temperature parameter may be determined to achieve a balance between exploration and exploitation. In the inference procedure, an initial state of the diffusion module may be determined based on a temperature parameter of the diffusion module. A plurality of states of the diffusion module may be determined based on the initial state and the temperature parameter by using the target latent feature as a condition. The speech sequence may be determined based on the plurality of states in a plurality of denoising steps. With these implementations, the temperature parameter may be used to implement a balance between exploration and exploitation.

Specifically, the present disclosure further provides temperature-based sampling, which strikes a balance between exploration and exploitation. Specifically, the temperature t E [0, 1] is defined as the time point to introduce noise while solving the reverse ODE of diffusion. For example, consider a Gaussian diffusion forward process defined on per-patch by xₜ==αₜx₀+σₜε, where x₀~q_{data}(x₀), ε~ [symbol] (0, I), t∈[0, 1], αₜ and σₜ collectively defines the flow path. At T=1, the sampling process is equivalent to the standard ODE sampling process, where the reverse ODE dxₜ=v_{θ}(xₜ, t)dt may be solved with respect to dt from 1 to 0, and x₁~ [symbol] (0, 1). At τ=0, no random noise is introduced leading to a completely deterministic process. Considering that 0 is the value with the highest likelihood in standard Gaussian distribution, the greedy sampling may be defined by sampling from x₁≡0, thus ensuring determinism.

In some implementations of the present disclosure, in order to determine the initial state of the diffusion module, the initial state of the diffusion model may be determined according to a Gaussian distribution in response to the temperature parameter being equal to an upper threshold of the temperature parameter. Alternatively and/or in addition to, the initial state of the diffusion model may be determined according to a predetermined value (for example, 0 or a value near 0) in response to the temperature parameter being less than an upper threshold of the temperature parameter. With these implementations, the temperature parameter may control the training procedure of the diffusion model such that the diffusion model may provide a balance between the exploration and exploitation.

In some implementations, 0<τ<1, the random noise at τ is introduced by using the forward process to diffuse an estimated x₁. For example, Formula (3) may be used to determine the initial state, and the Euler method is used as the default ODE solver for illustration.

$${x}_{1} ∼ \{ \begin{matrix}\text{?} ( 0 , I ) & if τ = 1 \\ 0 & if 0 \leq τ < 1\end{matrix} \qquad ( 3 )$$

In some implementations of the present disclosure, in order to determine the plurality of subsequent states of the diffusion module, a first state corresponding to a first step in a plurality of steps of the diffusion module may be determined based on the initial state and the target latent feature; the first state may be updated based on the temperature parameter; and a second state corresponding to a second step that follows the first step in the plurality of steps may be determined based on the updated first state and the target latent feature. With these implementations, the temperature may balance the exploration and exploitation. Here, the second state may be determined in an iterative process as below:

$${x}_{t} = \{ \begin{matrix}{x}_{t + Δ t} - {v}_{θ} ( {x}_{t + Δ t} , t + Δ t ) Δ t & if t \neq τ \\ {α}_{t} {x}_{θ} ( {x}_{t + Δ t} , t + Δ t ) + {σ}_{t} ε & if t = τ\end{matrix} \qquad ( 4 )$$

In the above formula, x_{θ} represents the estimated x₁, which can be derived from the estimated velocity or score through a linear transformation. Here, τ effectively balances diversity and stability. In some implementations of the present disclosure, predetermined noise data may be added into the state in response to the first step matching the temperature parameter. With these implementations, the speech generation may be controlled in a more effective way with balanced exploration and exploitation.

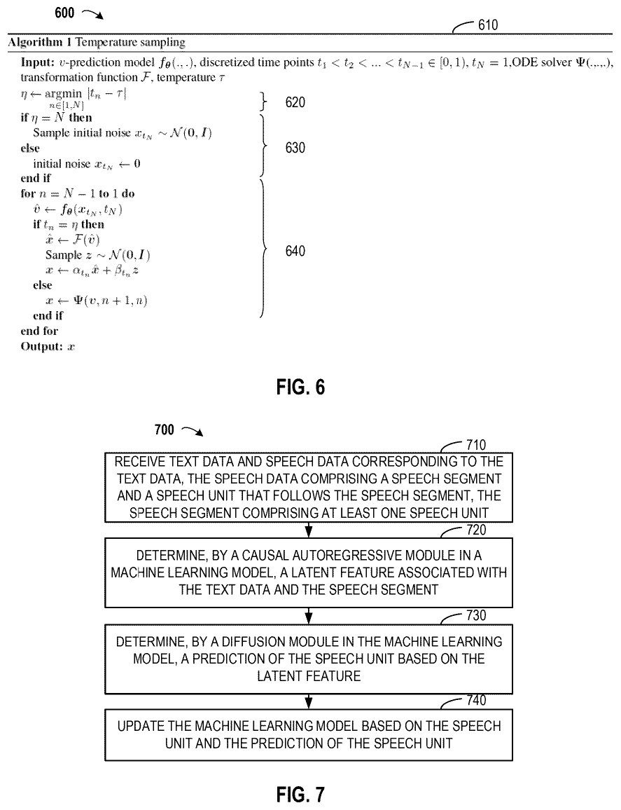

FIG. 6 illustrates an example procedure 600 of temperature sampling according to implementations of the present disclosure. As illustrated in FIG. 6, the algorithm 610 may be implemented for temperature sampling. In the algorithm 610, the input parameters comprises: the v-prediction model ƒ_{θ}( ) for predicting the velocity, the discretized time points t₁<t₂ . . . <t_{N-1}∈[0, 1], t_{N}=1, ODE solver Ψ( ) transformation function [symbol] , and the temperature t. The code 620 determines the nearest time point, the code 630 determines the initial noise, and the code 640 determines the noise at other time points.

In the present disclosure, a variational auto-encoder (VAE) is used to convert the waveform into the distribution of latent z, represented by mean and variance. The encoder of the VAE includes multiple layers of the convolutional network, and the decoder's architecture may follow any appropriate GAN architecture. The adversarial training scheme may be implemented, further multi-period discriminator (MPD) and multi-scale discriminator (MSD) may work as the discriminators. For example, the 24000 hz waveform is compressed into 40 hz (or a different frequency) latent with a dimension of 64 (or a different size).

The proposed solution may include three modules: an aggregation encoder, a language model, and a decoder. In the implementation, all of them may be based on the transformer architecture. Specifically, both the encoder and decoder may employ bidirectional attention masks, while the LM may utilize a causal attention mask. Each patch of continuous tokens, together with a learnable special token positioned at the beginning of the sequence similar to, is fed into the aggregation encoder. The output corresponding to the special token's position serves as the aggregation embedding. Aggregation embeddings from different patches form a sequence that is processed by the LM. In LocDiT, LM's outputs and the time embedding are added, along with historical context patches and noisy target tokens, forming a new sequence that serves as the input of LocDiT. When calculating the loss, only the output corresponding to the position of noisy target tokens are considered. During training, LM's output is randomly replaced by a vector of all zeros with a probability of 0.1 to enable LM guidance for LocDiT.

Regarding the diffusion formulation, a variance-preserving diffusion process may be defined by:

$${x}_{t} = {α}_{t} {x}_{0} + {σ}_{t} ε \qquad ( 5 )$$

$$= cos ( \frac{π t}{2} ) {x}_{0} + sin ( \frac{π t}{2} ) ε \qquad ( 6 )$$

In the above formula, x₀~q(x₀) denotes the data, ε18 [symbol] (0, I) denotes the standard Gaussian noise, t∈[0, 1]. A conditional flow-matching loss may be defined as:

$${L}_{diff} = {𝔼}_{t , {x}_{0} , ε} [ {‖ {v}_{θ} ( {x}_{t} , t ) - v ( {x}_{t} , t ) ‖}_{2}^{2} ] \qquad ( 7 )$$

In the above formula, the velocity is defined as: v(x|ₜ, t)=\dot{x}ₜ=\dot{α}ₜxᵣ+\dot{σ}ₜε. At inference time, the DDIM sampler may be used, which sampler is essentially the Euler ODE sampler with respect to signal-to-noise ratio

$$\frac{{α}_{t}^{2}}{{σ}_{t}^{2}}$$

instead of t, proved to better align with the semi-linear property of the diffusion ODE.

Regarding the zero-shot TTS system, the text sequence is converted into phonemes and processed through a lookup table to obtain text embeddings. Speech tokens are processed by the aggregation encoder to produce speech embeddings, which are then concatenated with the text embeddings. The embedding sequence serves as the input of the LM of the proposed solution. During training, the loss of the text is not included. Additionally, a binary classifier with a fully connected layer at LM's output is introduced to predict the time point to stop. The loss function for zero-shot TTS can be summarized as L=L_{diff}+Lₛₜₒₚ. During inference, prompting audio, text, and target text are fed as prefix input to the proposed solution's LM, which then autoregressively generates the target audio.

In some implementations of the present disclosure, the data sequence comprises text data, and the speech sequence has a random timbre. With these implementations, the machine learning model may be used to generate the speech data from the inputted text data without specifying the timbre of the speech data. In these implementations, the data sequence comprises only the text data but no speech data. At this point, the text data may be converted into phonemes and then the phonemes may be mapped into the text features based on a lookup table. Further, the causal autoregressive module may determine the target latent feature based on the text features.

In some implementations of the present disclosure, the data sequence comprises first text data, second text data, and first speech data corresponding to the first text data, and the speech data and the first speech data have a same timbre. With these implementations, the machine learning model may be used to generate the speech data from the inputted text data by specifying the timbre of the speech data. In these implementations, the data sequence comprises both the text data and the speech data. At this point, the text data may be converted into phonemes and then the phonemes may be mapped into the text features based on a lookup table. Meanwhile, the speech data may be represented by continuous speech tokens, and then these tokens may be divided into patches. The patches may be proceeded to obtain corresponding tokens and then form the continuous speech tokens. Further, the continuous speech tokens may be used to obtain the speech features. Then, the text features and the speech features may be concatenated, and the concatenation may be inputted into the causal autoregressive module, and then the target latent feature may be determined.

Open-source datasets may work as the training dataset, and four objective metrics may be used in the experiment. For example, 1) Word Error Rate (WER) may assess the generation robustness; 2) Speaker similarity to the prompt audio (SIM) may indicate the distance between the generated and reference speech; 3) Mean Opinion Score (MOS) may evaluate the speech quality; and 4) Floating point operations per second (FLOPS) may measure the computational load of models.

Regarding the model setup and baselines, the proposed solution may be benched against diverse zero-shot TTS systems with varying architectures, including both multi-stage and single-stage schemes that operate in discrete or continuous value spaces. A multi-dimensional comparison may be conducted between the proposed solution and other baseline models. For objective metrics, experiments show that the proposed solution has better technical effects. For example, regarding the generation robustness, the proposed solution consistently delivered the best WER, showcasing robust synthesis performance. Regarding the speaker similarity, the proposed solution delivers strong SIM scores, and demonstrates excellent in-context learning capabilities. Regarding the naturalness, the proposed solution excels over leading NAR systems, achieving the highest scores for naturalness. Regarding the audio quality, the proposed solution scores highly on MOS. Regarding the computational load, the proposed solution not only ensures high-quality audio generation but also dramatically cuts computational demands.

Regarding the scaling behaviors, the performance of the proposed solution consistently enhances as either data size or model size increases. Scaling experiments may be conducted concerning both data and model size. The training data is expanded from 20 k to 280 k hours with a 0.6 B model to assess performance changes. For model size, it is scaled from 0.1 B to 1 B parameters using 280 k hours of training data, simultaneously increasing the parameters of the encoder, language model, and LocDiT. For the detailed setups see Table 5. As shown in FIG. 2, the model's WER and SIM consistently improve as training data and model parameters increase.

The language model and diffusion decoder benefit more from scaling. The proposed solution scales the encoder, language model, and decoder individually to assess their impacts, starting with a 0.4 B parameter model. Given that the encoder and decoder process shorter sequences, more parameters are allocated to the language model empirically. Experiments demonstrate that enlarging the language model and LocDiT enhances performance, whereas increasing the encoder size has little effect on outcomes.

Temperature is vital for balancing diversity and determinism during language model inference, yet its definition for continuous-valued LMs remains underexplored. In this disclosure, the temperature τ is defined as the point at which random sampling is introduced during the reverse ODE solution. To explore how τ balances diversity and stability, the same text is synthesized 500 times under different τ settings to assess voice diversity. Only the text is used as the proposed solution's prefix input prompting the model to generate speech in random voices autoregressively. A speech processing model isused to extract speaker embeddings from these samples. Following this, Principal Component Analysis (PCA) is conducted, previously fitted on the training set, on the embeddings, and visualize the first two components. It demonstrates that as τ increases, so does the diversity of the speaker voices. WER and SIM are assessed for zero-shot speech synthesis across different temperatures τ, observing consistently excellent performance. Notably, higher temperatures slightly improve SIM scores, while lower temperatures enhance WER outcomes.

The proposed solution blends a language model with a diffusion transformer, inherits features from both components, and drastically cuts computational demands by allocating the majority of its parameters to the language model and fewer to LocDiT. In comparation between the existing diffusion model and the proposed solution under the same parameter sizes, during inference, all systems use CFG with NFE=10. The throughput may be evaluated, defined as the duration of audio generated per unit time, across various batch sizes by inferring 10 seconds of audio on an A100 GPU. With small batch sizes, the existing diffusion model achieves higher throughput due to lacking autoregressive computations. As batch sizes grow, the existing diffusion model's high FLOPS demands hinder throughput gains, while the proposed solution's throughput increases rapidly and is significantly superior to the existing diffusion model.

In the present disclosure, the proposed solution utilizes the diffusion transformer's capacity for high-quality generation to create localized patches while maintaining the core autoregressive features of language models. For the inference, the temperature works as the introduction time point for noise while solving the reverse diffusion ODE. Applied to zero-shot speech synthesis, the proposed solution achieves better robustness, speaker similarity, and naturalness with substantially lower computational requirements.

The above paragraphs have described details for the speech generation. According to implementations of the present disclosure, a method is provided for speech generation. Reference will be made to FIG. 7 for more details about the method, where FIG. 7 illustrates an example flowchart of a method 700 for speech generation according to implementations of the present disclosure. At block 710, text data and speech data corresponding to the text data are received, the speech data comprising a speech segment and a speech unit that follows the speech segment, the speech segment comprising at least one speech unit. At block 720, a causal autoregressive module in a machine learning model determines a latent feature associated with the text data and the speech segment. At block 730, a diffusion module in the machine learning model determines a prediction of the speech unit based on the latent feature. At block 740, the machine learning model is updated based on the speech unit and the prediction of the speech unit.

In implementations of the present disclosure, determining the latent feature comprises: determining, by an aggregation encoder in the machine learning model, at least one speech feature of the at least one speech unit; and obtaining, by the causal autoregressive module, the latent feature based on a text feature of the text data and the least one speech feature.

In implementations of the present disclosure, determining the prediction of the speech unit based on the latent feature comprises: updating the latent feature according to a predetermined criterion; and determining the prediction of the speech unit based on the updated latent feature.

In implementations of the present disclosure, updating the latent feature comprises: clearing at least a portion of the latent feature.

In implementations of the present disclosure, the speech unit is determined based on a predetermined interval from the speech data, the text feature of the text data is determined based on at least one phoneme corresponding to the text data, and obtaining the latent feature comprises: obtaining the latent feature based on a concatenation of the text feature of the text data and the least one speech feature.

In implementations of the present disclosure, the method further comprises: determining, by the causal autoregressive module, a target latent feature associated with a data sequence in response to receiving the data sequence; and determining, by the diffusion module, a speech sequence corresponding to the data sequence based on the target latent feature.

In implementations of the present disclosure, determining the speech sequence comprises: determining an initial state of the diffusion module based on the target latent feature and a temperature parameter of the diffusion module; determining a plurality of states of the diffusion module based on the initial state and the temperature parameter by using the target latent feature as a condition; and determining the speech sequence based on the plurality of states.

In implementations of the present disclosure, determining the initial state of the diffusion module comprises: determining the initial state of the diffusion model according to a Gaussian distribution in response to the temperature parameter being equal to an upper threshold of the temperature parameter; or determining the initial state of the diffusion model according to a predetermined value in response to the temperature parameter being less than an upper threshold of the temperature parameter.

In implementations of the present disclosure, determining the plurality of states of the diffusion module comprises: determining, based on the initial state and the target latent feature, a first state corresponding to a first step in a plurality of steps of the diffusion module; updating the first state based on the temperature parameter; and determining, based on the updated first state and the target latent feature, a second state corresponding to a second step that follows the first step in the plurality of steps.

In implementations of the present disclosure, updating the first state based on the temperature parameter comprises: adding predetermined noise data into the first state in response to the first step matching the temperature parameter.

In implementations of the present disclosure, the data sequence comprises text data, and the speech sequence has a random timbre; or the data sequence comprises first text data, second text data, and first speech data corresponding to the first text data, and the speech data and the first speech data have a same timbre.

According to implementations of the present disclosure, an apparatus is provided for speech generation. The apparatus comprises: a receiving module, configured to receive text data and speech data corresponding to the text data, the speech data comprising a speech segment and a speech unit that follows the speech segment, the speech segment comprising at least one speech unit; a first determining module, configured to determine, by a causal autoregressive module in a machine learning model, a latent feature associated with the text data and the speech segment; a second determined module, configured to determine, by a diffusion module in the machine learning model, a prediction of the speech unit based on the latent feature; and an updating module, configured to update the machine learning model based on the speech unit and the prediction of the speech unit. Further, the apparatus may comprise other units for implementing other steps in the method 700.

According to implementations of the present disclosure, an electronic device is provided for implementing the method 700. The electronic device comprises: a computer processor coupled to a computer-readable memory unit, the memory unit comprising instructions that when executed by the computer processor implements a method for speech generation. The method comprises: receiving text data and speech data corresponding to the text data, the speech data comprising a speech segment and a speech unit that follows the speech segment, the speech segment comprising at least one speech unit; determining, by a causal autoregressive module in a machine learning model, a latent feature associated with the text data and the speech segment; determining, by a diffusion module in the machine learning model, a prediction of the speech unit based on the latent feature; and updating the machine learning model based on the speech unit and the prediction of the speech unit.

In implementations of the present disclosure, determining the latent feature comprises: determining, by an aggregation encoder in the machine learning model, at least one speech feature of the at least one speech unit; and obtaining, by the causal autoregressive module, the latent feature based on a text feature of the text data and the least one speech feature.

In implementations of the present disclosure, determining the prediction of the speech unit based on the latent feature comprises: updating the latent feature according to a predetermined criterion; and determining the prediction of the speech unit based on the updated latent feature.

In implementations of the present disclosure, updating the latent feature comprises: clearing at least a portion of the latent feature.

In implementations of the present disclosure, the speech unit is determined based on a predetermined interval from the speech data, the text feature of the text data is determined based on at least one phoneme corresponding to the text data, and obtaining the latent feature comprises: obtaining the latent feature based on a concatenation of the text feature of the text data and the least one speech feature.

In implementations of the present disclosure, the method further comprises: determining, by the causal autoregressive module, a target latent feature associated with a data sequence in response to receiving the data sequence; and determining, by the diffusion module, a speech sequence corresponding to the data sequence based on the target latent feature.

In implementations of the present disclosure, determining the speech sequence comprises: determining an initial state of the diffusion module based on a temperature parameter of the diffusion module; determining a plurality of states of the diffusion module based on the initial state and the temperature parameter by using the target latent feature as a condition; and determining the speech sequence based on the initial state and the plurality of states.

In implementations of the present disclosure, determining the initial state of the diffusion module comprises: determining the initial state of the diffusion model according to a Gaussian distribution in response to the temperature parameter being equal to an upper threshold of the temperature parameter; or determining the initial state of the diffusion model according to a predetermined value in response to the temperature parameter being less than an upper threshold of the temperature parameter.

In implementations of the present disclosure, determining the plurality of states of the diffusion module comprises: determining, based on the initial state and the target latent feature, a first state corresponding to a first step in a plurality of steps of the diffusion module; updating the first state based on the temperature parameter; and determining, based on the updated first state and the target latent feature, a second state corresponding to a second step that follows the first step in the plurality of steps.

In implementations of the present disclosure, updating the first state based on the temperature parameter comprises: adding predetermined noise data into the first state in response to the first step matching the temperature parameter.

In implementations of the present disclosure, the data sequence comprises text data, and the speech sequence has a random timbre; or the data sequence comprises first text data, second text data, and first speech data corresponding to the first text data, and the speech data and the first speech data have a same timbre.

According to implementations of the present disclosure, a computer program product, the computer program product comprising a computer readable storage medium having program instructions embodied therewith, the program instructions executable by an electronic device to cause the electronic device to perform the method 700.

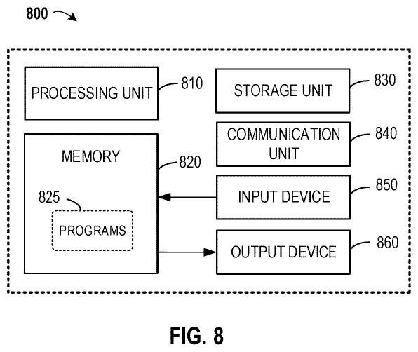

FIG. 8 illustrates a block diagram of a computing device 800 in which various implementations of the present disclosure can be implemented. It would be appreciated that the computing device 800 shown in FIG. 8 is merely for purpose of illustration, without suggesting any limitation to the functions and scopes of the present disclosure in any manner. The computing device 800 may be used to implement the above method 1000 in implementations of the present disclosure. As shown in FIG. 8, the computing device 800 may be a general-purpose computing device. The computing device 800 may at least comprise one or more processors or processing units 810, a memory 820, a storage unit 830, one or more communication units 840, one or more input devices 850, and one or more output devices 860.

The processing unit 810 may be a physical or virtual processor and can implement various processes based on programs stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller, or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk, or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem, and the like) enabling the computing device 800 to communicate with one or more other computing devices, if required. Such communication can be performed via input/output (I/O) interfaces (not shown).

In some implementations, instead of being integrated in a single device, some, or all components of the computing device 800 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

1. A method for speech generation, comprising:
receiving text data and speech data corresponding to the text data, the speech data comprising a speech segment and a speech unit that follows the speech segment, the speech segment comprising at least one speech unit;
determining, by a causal autoregressive module in a machine learning model, a latent feature associated with the text data and the speech segment;
determining, by a diffusion module in the machine learning model, a prediction of the speech unit based on the latent feature; and
updating the machine learning model based on the speech unit and the prediction of the speech unit.

2. The method of claim 1, wherein determining the latent feature comprises:
determining, by an aggregation encoder in the machine learning model, at least one speech feature of the at least one speech unit; and
obtaining, by the causal autoregressive module, the latent feature based on a text feature of the text data and the least one speech feature.

3. The method of claim 1, wherein determining the prediction of the speech unit based on the latent feature comprises:
updating the latent feature according to a predetermined criterion; and
determining the prediction of the speech unit based on the updated latent feature.

4. The method of claim 3, wherein updating the latent feature comprises: clearing at least a portion of the latent feature.

5. The method of claim 2, wherein the speech unit is determined based on a predetermined interval from the speech data, the text feature of the text data is determined based on at least one phoneme corresponding to the text data, and obtaining the latent feature comprises: obtaining the latent feature based on a concatenation of the text feature of the text data and the least one speech feature.

6. The method of claim 1, further comprising:
determining, by the causal autoregressive module, a target latent feature associated with a data sequence in response to receiving the data sequence; and
determining, by the diffusion module, a speech sequence corresponding to the data sequence based on the target latent feature.

7. The method of claim 6, wherein determining the speech sequence comprises:
determining an initial state of the diffusion module based on a temperature parameter of the diffusion module;
determining a plurality of states of the diffusion module based on the initial state and the temperature parameter by using the target latent feature as a condition; and
determining the speech sequence based on the plurality of states.

8. The method of claim 7, wherein determining the initial state of the diffusion module comprises:
determining the initial state of the diffusion model according to a Gaussian distribution in response to the temperature parameter being equal to an upper threshold of the temperature parameter; or
determining the initial state of the diffusion model according to a predetermined value in response to the temperature parameter being less than an upper threshold of the temperature parameter.

9. The method of claim 7, wherein determining the plurality of states of the diffusion module comprises:
determining, based on the initial state and the target latent feature, a first state corresponding to a first step in a plurality of steps of the diffusion module;
updating the first state based on the temperature parameter; and
determining, based on the updated first state and the target latent feature, a second state corresponding to a second step that follows the first step in the plurality of steps.

10. The method of claim 9, wherein updating the first state based on the temperature parameter comprises: adding predetermined noise data into the first state in response to the first step matching the temperature parameter.

11. The method of claim 5, wherein:
the data sequence comprises text data, and the speech sequence has a random timbre; or
the data sequence comprises first text data, second text data, and first speech data corresponding to the first text data, and the speech data and the first speech data have a same timbre.

12. An electronic device, comprising a computer processor coupled to a computer-readable memory unit, the memory unit comprising instructions that when executed by the computer processor implements a method for speech generation, the method comprising:
receiving text data and speech data corresponding to the text data, the speech data comprising a speech segment and a speech unit that follows the speech segment, the speech segment comprising at least one speech unit;
determining, by a causal autoregressive module in a machine learning model, a latent feature associated with the text data and the speech segment;
determining, by a diffusion module in the machine learning model, a prediction of the speech unit based on the latent feature; and
updating the machine learning model based on the speech unit and the prediction of the speech unit.

13. The device of claim 12, wherein determining the latent feature comprises:
determining, by an aggregation encoder in the machine learning model, at least one speech feature of the at least one speech unit; and
obtaining, by the causal autoregressive module, the latent feature based on a text feature of the text data and the least one speech feature.

14. The device of claim 12, wherein determining the prediction of the speech unit based on the latent feature comprises:
updating the latent feature according to a predetermined criterion; and
determining the prediction of the speech unit based on the updated latent feature.

15. The device of claim 14, wherein updating the latent feature comprises: clearing at least a portion of the latent feature.

16. The device of claim 12, wherein the method further comprises:
determining, by the causal autoregressive module, a target latent feature associated with a data sequence in response to receiving the data sequence; and
determining, by the diffusion module, a speech sequence corresponding to the data sequence based on the latent feature.

17. The device of claim 16, wherein determining the speech sequence comprises:
determining an initial state of the diffusion module based on a temperature parameter of the diffusion module;
determining a plurality of states of the diffusion module based on the initial state and the temperature parameter by using the target latent feature as a condition; and
determining the speech sequence based on the plurality of states.

18. The device of claim 17, wherein determining the initial state of the diffusion module comprises:
determining the initial state of the diffusion model according to a Gaussian distribution in response to the temperature parameter being equal to an upper threshold of the temperature parameter; or
determining the initial state of the diffusion model according to a predetermined value in response to the temperature parameter being less than an upper threshold of the temperature parameter.

19. The device of claim 18, wherein determining the plurality of states of the diffusion module comprises:
determining, based on the initial state and the target latent feature, a first state corresponding to a first step in a plurality of steps of the diffusion module;
updating the first state based on the temperature parameter; and
determining, based on the updated first state and the target latent feature, a second state corresponding to a second step that follows the first step in the plurality of steps.

20. A non-transitory computer program product, the non-transitory computer program product comprising a computer readable storage medium having program instructions embodied therewith, the program instructions executable by an electronic device to cause the electronic device to perform a method for speech generation, the method comprising:
receiving text data and speech data corresponding to the text data, the speech data comprising a speech segment and a speech unit that follows the speech segment, the speech segment comprising at least one speech unit;
determining, by a causal autoregressive module in a machine learning model, a latent feature associated with the text data and the speech segment;
determining, by a diffusion module in the machine learning model, a prediction of the speech unit based on the latent feature; and
updating the machine learning model based on the speech unit and the prediction of the speech unit.
